(19) United States
(12) Patent Application Publication
(10) Pub. No.: US 2010/0312635 A1
(43) Pub. Date: Dec. 9, 2010

(54) FREE SAMPLE COUPON CARD

(76) Inventor: Karen L. Cervenka, Belmont, CA (US)

Correspondence Address: Quarles & Brady LLP, TWO NORTH CENTRAL AVENUE, One Renaissance Square, PHOENIX, AZ, 85004-2391, US

(21) Appl. No.: 12/545,372

(22) Filed: Aug. 21, 2009

Related U.S. Application Data
(63) Continuation-in-part of application No. 12/480,346, filed on Jun. 8, 2009.
Application No. 12/480,346 is a continuation-in-part of application No. 12/480,268, filed on Jun. 8, 2009.
Application No. 12/480,268 is a continuation-in-part of application No. 12/480,346, filed on Jun. 8, 2009.
Application No. 12/480,346 is a continuation-in-part of application No. 12/480,444, filed on Jun. 8, 2009.
Application No. 12/480,444 is a continuation-in-part of application No. 12/480,529, filed on Jun. 8, 2009.
Application No. 12/480,529 is a continuation-in-part of application No. 12/480,551, filed on Jun. 8, 2009.

(51) Int. Cl. G06Q 30/00; G06K 19/07; G06K 19/06

(52) U.S. Cl. 705/14.38; 705/14.1; 235/492; 235/494

(57) ABSTRACT

A portable coupon payment device includes a substrate having surface with an image rendering thereon that corresponds to a free sample. The portable coupon payment device also has memory, in contact with the substrate, having data encoded therein including (i) an identifier for the free sample, (ii) a quantity for the free sample; (iii) a sponsor company account for a selling merchant to charge the cost of the free sample for payment to a selling merchant account to reimburse the selling merchant for the free sample; (iv) an image corresponding to the free sample; and (v) an identifier for a coupon provider donating the free sample to a consumer.

### CROSS-REFERENCE TO RELATED APPLICATIONS

The case is a continuation in part of each of the following utility applications: (i) U.S. patent application Ser. No. 12/480,268, filed on Jun. 8, 2009, by Karen Cervenka, titled Coupon Card Generation Web Service; (ii) U.S. patent application Ser. No. 12/480,346, filed on Jun. 8, 2009, by Karen Cervenka, titled Dual Range Cellular Telephone Coupon Card Generation; (iii) U.S. patent application Ser. No. 12/480,444, filed on Jun. 8, 2009, by Karen Cervenka, titled Coupon Card Kiosk; (iv) U.S. patent application Ser. No. 12/480,529, filed on Jun. 8, 2009, by Karen Cervenka, titled Coupon Card Point Of Service Terminal Processing; and (v) U.S. patent application Ser. No. 12/480,551, filed on Jun. 8, 2009, by Karen Cervenka, titled Transaction Handler Merchant Reimbursement For Consumer Transaction Use Of Sponsor Discount Coupon Card. Each of the foregoing utility applications is incorporated herein by reference.

### FIELD

The present invention is related to a transaction between a merchant and a consumer, is more particularly related to a discount on such a transaction, and is most particularly related to a coupon being presented by the consumer to the merchant to obtain the discount on the transaction.

### BACKGROUND

The present invention relates generally to the application of coupons, and more particularly to the processing of electronic coupon stored on a coupon card to a purchase by a payment processing system.

Consumers obtain paper coupons in a variety of ways. They may cut them out of a newspaper or receive them at a Point of Service (POS) terminal when making a purchase. Sometimes paper coupons are mailed to consumers by the sponsor of the coupon or other entity. Each of these distribution methods, however, are associated recurring costs. Every time a manufacturer or merchant decides to offer a paper coupon they must pay to have them printed and distributed.

Moreover, paper coupons are cumbersome and easily lost. Many consumers spend valuable time clipping the paper coupons they want from newspapers. Those who use a large number of paper coupons often spend additional time sorting the coupons into categories so that a particular coupon is easier to find. Further, customers will often receive the paper coupon some time before they intend to use it. The consumer must then store the paper coupon until they go shopping.

Additionally, consumers may not receive paper coupons for specific items they buy even though the coupons are available from a manufacturer or merchant. The consumer may not be on the mailing list to receive the coupon or it may not have been printed in the newspaper they buy. In some cases this may cause the consumer to forego purchasing a specific item in favor of a less costly alternative.

Thus, there is a need for a system that reduces the costs incurred by merchants and manufacturers in offering coupons as well as one that allows consumers to be able to quickly find and obtain the coupons they want.

### SUMMARY

Disclosed implementations include a portable coupon payment device having a substrate in contact with memory having encoded data corresponding to a free sample and quantity thereof, as well as an identifier for a sponsor of the free sample who will reimburse a merchant for the cost of the free sample donated to a consumer presenting the portable coupon payment device to the merchant.

The foregoing advantages of the inventions will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment where an coupon card may be used by a card holder to obtain a discount on a purchase;

FIG. 2 depicts a block diagram of a method of using a kiosk to obtain a coupon card associated with an electronic coupon;

FIG. 3 illustrates possible alternative implementations of the data encoding area of a coupon card;

FIG. 4 depicts the environment within FIG. 1 where a coupon card is used by a consumer to obtain a discount on a purchase;

FIG. 5 depicts a flow chart of an exemplary method used by a POS terminal to process an electronic coupon stored on a coupon card.

### DETAILED DESCRIPTION

The present discussion considers a coupon card and its use in a payment processing system that processes electronic coupons stored on the coupon card. In the present context, an account for the payment of future discounts on goods and services attributable to the use of electronic coupons is issued by the issuer to a third-party and credited with funds submitted by the third-party. The funds are for reimbursement of discounts on the sale of goods and services given by a merchant upon the presentation of a coupon card having at least one of the electronic coupons stored thereon.

In one implementation, a portable coupon payment device is presented. The portable coupon payment device includes a substrate having surface with an image rendering thereon that corresponds to a free sample. The portable coupon payment device also has memory, in contact with the substrate, having data encoded therein including (i) an identifier for the free sample, (ii) a quantity for the free sample; (iii) a sponsor company account for a selling merchant to charge the cost of the free sample for payment to a selling merchant account to reimburse the selling merchant for the free sample; (iv) an image corresponding to the free sample; and (v) an identifier for a coupon provider donating the free sample to a consumer.

In another implementation, a portable coupon transaction payment device is presented. The portable coupon transaction payment device has memory embedded in a substrate. Stored in the memory are an identifier and a quantity for each of a plurality of a free sample donated by a coupon provider to a consumer and a non-sample item each being offered by a corresponding coupon provider to the consumer. Also stored, for each free sample, is a sponsor company account for a selling merchant to charge the cost of the free sample for payment to a selling merchant account to reimburse the selling merchant for the free sample. Also stored is an identifier for the consumer. Also stored, is an identifier for each coupon provider. Also stored is an identifier for a consumer account issued by an issuer to the consumer. Also stored is an identifier to correlate which donation for the consumer was donated by which coupon provider. The sponsor company account and the consumer account are each an account in a payment processing network by which a consumer can engage in a plurality of transactions on the account with a plurality of merchants in the payment processing network. The payment processing network includes a plurality of merchants and consumers engaging in the plurality of transactions on a plurality of respective accounts that respective issuers issue to the consumers. Each transaction involves the merchant submitting the transaction to an acquirer for processing by a transaction handler who requests the issuer to obtain payment for the transaction from the account, wherein the issuer forwards the payment to the transaction handler who forwards the payment to the acquirer to reimburse the merchant for the transaction. The portable coupon transaction payment device also includes means for providing access to the information in the memory.

In yet another implementation, a portable coupon transaction payment device is presented. The portable coupon transaction payment device has memory embedded in a substrate. The memory has information stored therein. The substrate has an image on a surface thereof that includes a representation of at least a portion of the information in the memory for being read by the image being scanned by a scanner at a Point of Service terminal. The stored information includes (i) an identifier and a quantity for each of a plurality of a free sample donated by a coupon provider to a consumer and a non-sample item offered by a corresponding coupon provider to the consumer; (ii) an image, having multiple portion, of each donation for the consumer that was donated by the corresponding coupon provider, wherein the portions of the image correspond to the identifier for the consumer, the identifier for the coupon provider; the identifier and the quantity for the free sample; and the identifier and the quantity for the non-sample item; (iii) for each free sample, a sponsor company account for a selling merchant to charge the cost of the free sample for payment to a selling merchant account to reimburse the selling merchant for the free sample; and (iv) an identifier to correlate which donation for the consumer was donated by which coupon provider. The sponsor company account and the consumer account are each an account in a payment processing network by which a consumer can engage in a plurality of transactions on the account with a plurality of merchants in the payment processing network. The payment processing network includes a plurality of merchants and consumers engaging in the plurality of transactions on a plurality of respective accounts that respective issuers issue to the consumers. Each transaction involves the merchant submitting the transaction to an acquirer for processing by a transaction handler who requests the issuer to obtain payment for the transaction from the account, wherein the issuer forwards the payment to the transaction handler who forwards the payment to the acquirer to reimburse the merchant for the transaction. The portable coupon transaction payment device also has means for providing access to the information in the memory.

In alternatives to the foregoing implementations, the memory can be a non-volatile memory of a semiconductor device, a magnetic encoded data region of a magnetic stripe, or a combination of the foregoing. The substrate can be a portion of a consumer transaction payment card (e.g. a smart card having a Radio Frequency Identification (RFID) tag, a transponder device and a microchip, a magstripe card, or a combination of the foregoing. The portable coupon transaction payment device can include circuitry and corresponding firmware, as would be understood by those of skill in the relevant arts, for the memory to receive the information by a wireless communication, a hardwired communication, or a magnetic encoded communication for track data received by modifying the magnetism of magnetic particles on a band of magnetic material on the portable coupon payment device. For each image of each donation, the identifier for the coupon provider can be a handwritten signature of the coupon provider. Alternatively, for each image of each free sample, the free sample in the image can be hand written by the coupon provider.

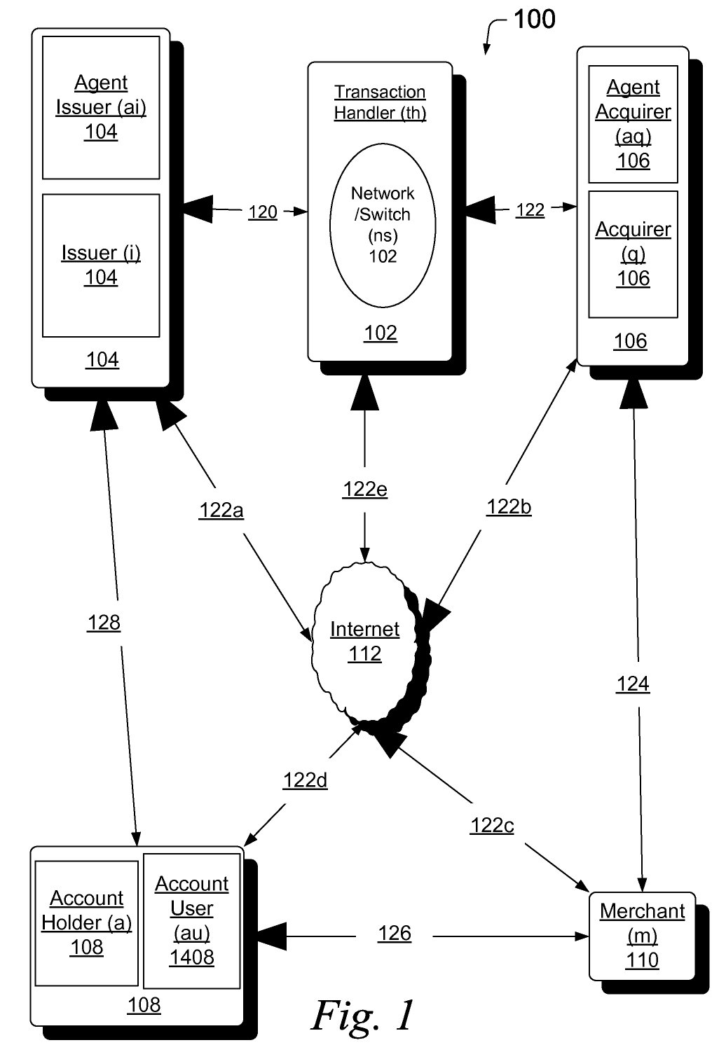

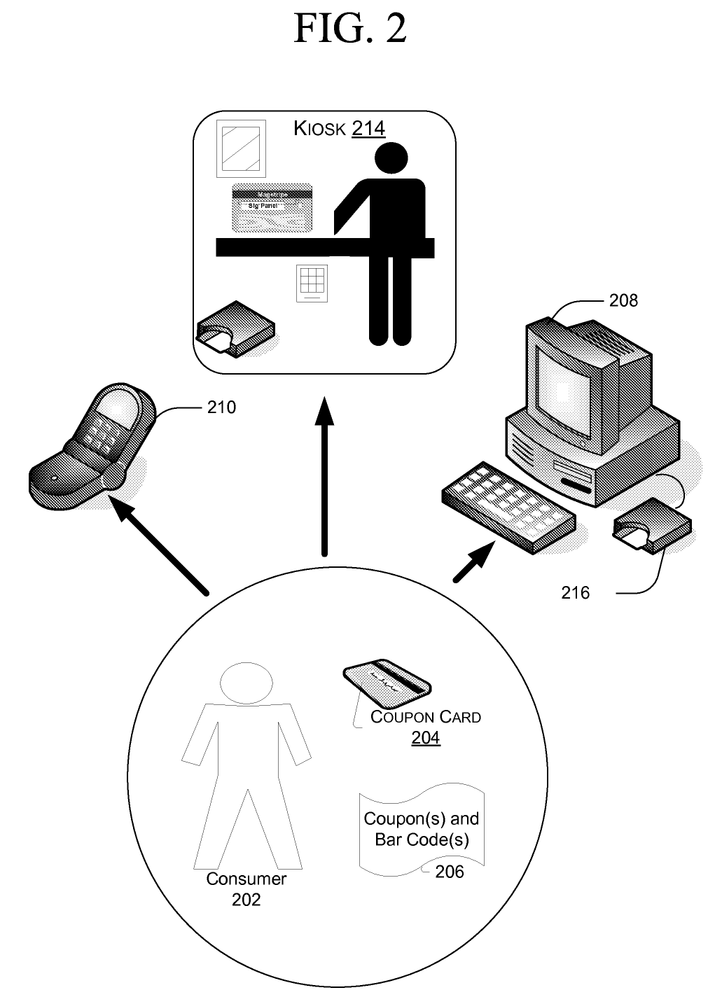

Within the exemplary payment processing system depicted in FIG. 1, discussed in detail below, FIG. 2 illustrates a block diagram depicting a consumer's exemplary use of a kiosk that associates a coupon card with at least one electronic coupon that the consumer has selected, by use of the kiosk, that may be used to obtain a discount on the purchase of goods and services by the consumer from a merchant. Although the implementation is discussed in regards to a substantially planar laminated card, one skilled in the art will recognize that other forms of transaction tokens (i.e., portable consumer payment devices) could be used in the disclosed method.

In the illustrated implementation of FIG. 2, consumer 202 may associate a coupon card 204 with at least one electronic coupon using several methods. In one implementation, consumer 202 uses a web-enabled computer system 208 to connect to the World Wide Web, the Internet, or other network, and browse to a website having electronic coupons available for downloading as facilitated by a web service. In such an implementation, consumer 202 uses the browser to select at least one of the electronic coupons offered. Information relating to that electronic coupon is then downloaded to computer system 208, including an account identifier for the party offering, and willing to pay for the discount provide by, the electronic coupon.

In certain implementations, the information further includes the type of product or service, or category thereof, for which the electronic coupon is valid. By way of example and not limitation, the electronic coupon may be valid for all cleaning products made by a particular manufacturer. Alternatively, the electronic coupon may be valid for a specific dish soap made by the manufacturer.

In other implementations, the information also includes a merchant or manufacturer with which the electronic coupon is valid. In such an implementation, the electronic coupon may only be valid for use with a particular merchant or only for the purchase of a particular manufacturer's product. In other implementations, the information includes an expiration date, after which the electronic coupon is no longer valid. In yet other implementations, the information includes the number of goods or services eligible for a discount using the electronic coupon. By way of example and not limitation, the electronic coupon may be valid for discounts on up to three (3) bottles of a pain reliever. Alternatively, the electronic coupon may only be used when ten (10) car washes are purchased at the same time.

In certain implementations, the information also includes a bar code identifying the item or type of item for which the electronic coupon is valid. In such an implementation, the bar code is rendered on a print out 206 using a printer connected to computer system 208. The bar code may later be scanned by a scanner of a POS terminal to identify the item being purchased that is eligible for a discount using the electronic coupon.

Print out 206 includes a scannable copy of the bar code such that it may be later scanned by a scanner at a POS terminal to identify the type of item eligible for a discount using the electronic coupon. Print out 206 also serves as a reminder to consumer 202 of which electronic coupons are stored on coupon card 204.

In certain implementations, print out 206 includes advertisements. In certain implementations, print out 206 additionally includes information regarding soon-to-be-available electronic coupons.

Once the information relating to the selected electronic coupon is downloaded to computer system 208, the account identifier is written to a coupon card 204 using card read-write device 216. In certain implementations, card read-write device 216 is attached as a peripheral to computer system 208. In certain implementations, card read-write device 216 is a memory card reader. In such an implementation, coupon card 204 is a smart card and the account identifier is stored in the memory of an embedded chip. In certain implementations, coupon card 204 is a contact smart card having a contact area that when inserted into card read-write device 216 makes contact with electrical connectors capable of writing the information to memory. In certain implementations, coupon card 204 is a contactless smart card in which the chip communicates with card read-write device 216 through radio-frequency identification (RFID) induction technology.

In certain implementations, card read-write device 216 is a magnetic card reader. In such an implementation, coupon card 204 has a magnetic data stripe. The account identifier is stored on coupon card 204 when the magnetic data stripe is placed in physical contact with a read-write head of card read-write device 216.

In certain implementations, coupon card 204 includes both an embedded chip and a magnetic stripe. In other implementations, coupon card 204 is also a portable consumer device, such as a credit card, debit card, prepaid card, loyalty card or other such device associated with an account of consumer 202. In such implementations, consumer 202 may use coupon card 204 to both receive a discount and pay for the item.

In the illustrated implementation of FIG. 2, consumer 202 may also associate coupon card 204 with at least one electronic coupon using a dual range (i.e., long range wireless communications and short range wireless communications), web-enabled cellular telephone 210, where coupon card 204 is a smart card. In such implementations, consumer 202 uses the cellular telephony functionality of cellular telephone 210 to connect to the Internet or World Wide Web and browse to a website having electronic coupons provided by a web service. Upon selecting an electronic coupon, the associated information is downloaded to cellular telephone 210, including the account identifier for the third-party sponsoring the electronic coupon.

In such implementations where the information downloaded also includes a bar code, the bar code is capable of being rendered on the display of cellular telephone 210. The bar code can later be scanned by a scanner at a POS terminal to identify the type of item eligible for a discount using the electronic coupon.

Once the information relating to the selected electronic coupon is downloaded to cellular telephone 210, the account identifier associated with the sponsor of the electronic coupon is written to coupon card 204 using a moblet stored on cellular telephone 210. The moblet is executed to provide functionality to short range wireless communication that writes to the memory of coupon card 204, such as via a near field communication (NFC) card read-write application capable of using wireless NFC to read and write data to the memory of coupon card 204.

In the illustrated implementation of FIG. 2, consumer 202 may also associate a coupon card 204 with at least one electronic coupon using a kiosk 214. Kiosk 214 is in communication with a database (not shown), preferably kept in one or more device storage devices, capable of storing and relating information regarding the available electronic coupons. In one implementation, a third-party offering at least one electronic coupon has access to the database and may send to and receive from the database information such as the number of electronic coupons used, the number of electronic coupons remaining, or any other relevant information.

When using kiosk 214, consumer 202 is presented with a user interface displaying a plurality of electronic coupons and uses an input device to make a selection. In one implementation, consumer 202 then receives from kiosk 214 a coupon card 204. In such an implementation, kiosk 214 includes a stack of blank coupon cards which may be issued to consumer 202. In other implementations, consumer 202 obtains coupon card 204 and provides it to kiosk 214 via a card receiving device to have the selected electronic coupons stored thereon. In such implementations, consumer 202 may purchase coupon card 204 from a merchant. In other implementations, consumer 202 may receive coupon card 204 from the third-party, a merchant, or any other entity having an interest in providing electronic coupons. In yet other implementations, coupon card 204 is also a portable consumer device and is issued by an issuer to consumer 202 (i.e., the consumer's credit, debit, gift, or pre-paid card).

In using kiosk 214 to associate coupon card 204 with at least one electronic coupon, kiosk 214 stores information relating to the electronic coupon selected by consumer 202 on coupon card 204, including the account identifier associated with an account of the electronic coupon sponsor.

In those implementations where the selected electronic coupon is also associated with a bar code identifying the type of item for which the electronic coupon is valid, kiosk 214 additionally dispensed to consumer 202 a print out 206 having the bar code printed thereon. The print out may later be scanned by a scanner at a POS terminal, as would a typical coupon.

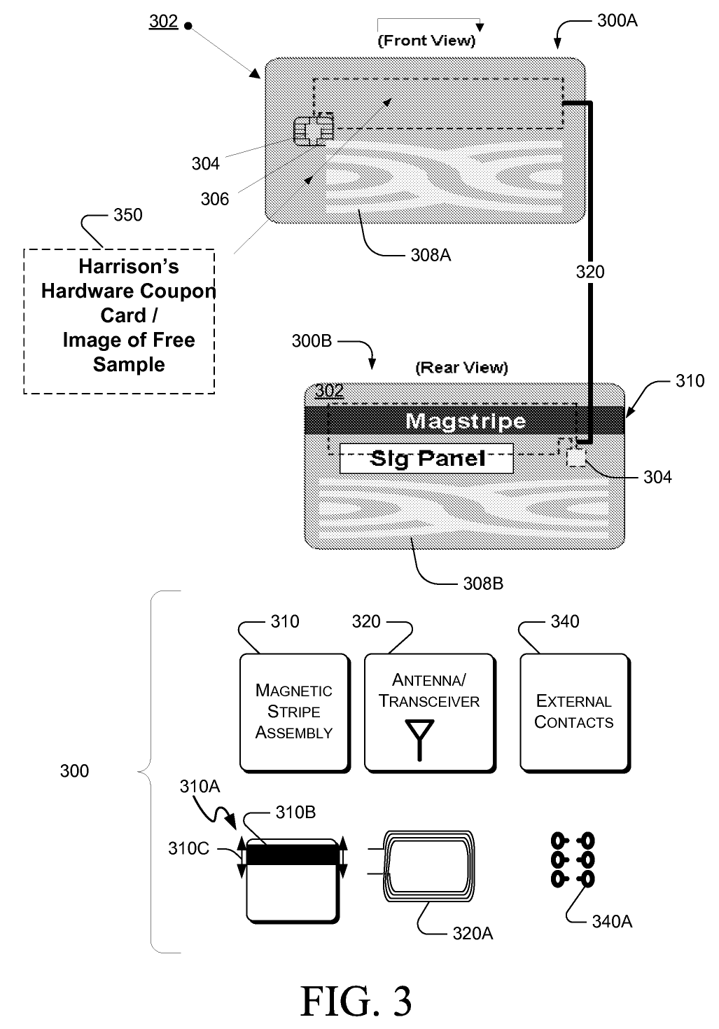

Turning to FIG. 3, both a front view 300A and a rear view 300B of an exemplary coupon card 302 are presented. Images may be displayed on both sides of coupon card 302, with image 308A on the front view 300A being either the same as or different from image 308B on the rear view 300B. In this illustration, the front view 300A also displays information about the provider of the coupon card.

FIG. 3 also shows exemplary implementations of a data encoding area of coupon card 302. The data encoding area may include an optional shielding element, which allows desired electromagnetic, optical, or radiative signals to penetrate while protecting the data encoding area from physical abuse or damage. Coupon card 302 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 300, and include an integrated circuit or ‘chip’ 304 having contact(s) 306, a magnetic stripe assembly 310, an antenna and/or transceiver 320, and electrical contacts 340. Magnetic stripe assembly 310 may comprise, in the implementation shown as 310A, a reprogrammable magnetic stripe assembly 310B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 310, rendering the card useless in the event of its loss or theft. In the implementation shown as 310A, magnetic stripe assembly 310B at least partially slidably moves 310C into and out of an assembly of coupon card 302 (partial view shown), allowing coupon card 302 to conduct a transaction at a point of sale terminal that includes a magnetic stripe reader.

Coupon card 302 can bear, on a surface thereof, an image 350 of a free sample and/or the offeror of the free sample. Memory, such as may be contained in chip 304, can have encoded therein, but is not limited to, (i) an identifier for the free sample (e.g., UPC, SKU, Bar Code data, etc); (ii) a quantity for the free sample; (iii) a sponsor company account for a selling merchant to charge the cost of the free sample for payment to a selling merchant account to reimburse the selling merchant for the free sample; (iv) data for rendering an image corresponding to the free sample; and (v) an identifier for a coupon provider donating the free sample to the consumer who presents the coupon card to the selling merchant.

Continuing with FIG. 3, another implementation of the data encoding area is shown as an antenna and/or transceiver 320. Antenna and/or transceiver 320 may include commonly used loop inductors such as the one shown 320A or in those shown in related ISO standards for RF-readable smart cards. With such an interface, account data may be translated, modulated and transmitted in a manner acceptable by an RF contactless merchant POS terminal, a 802.11 WiFi or WiMax network, or by a cellular or RF communications network. For instance, antenna and/or transceiver 320 may receive a wireless communication from a card read-write device, where the wireless communication carries data for a manufacturer's discount coupon account that is to be written in memory to the data encoding area 300.

Electrical contacts 340 are yet another alternative implementation of the data encoding area shown in FIG. 3. With coupon card 302 possessing physical contacts such as an array of conductive pads or shapes 340A, coupon card 302 may be placed in physical contact with a merchant POS terminals, and electrical contacts 340 may establish connectivity to the merchant's financial processing system. The processor may relay account-related information to the merchant POS terminal through the contact interface, thereby allowing coupon card 302 to be utilized with the large number of preexisting merchant POS terminals.

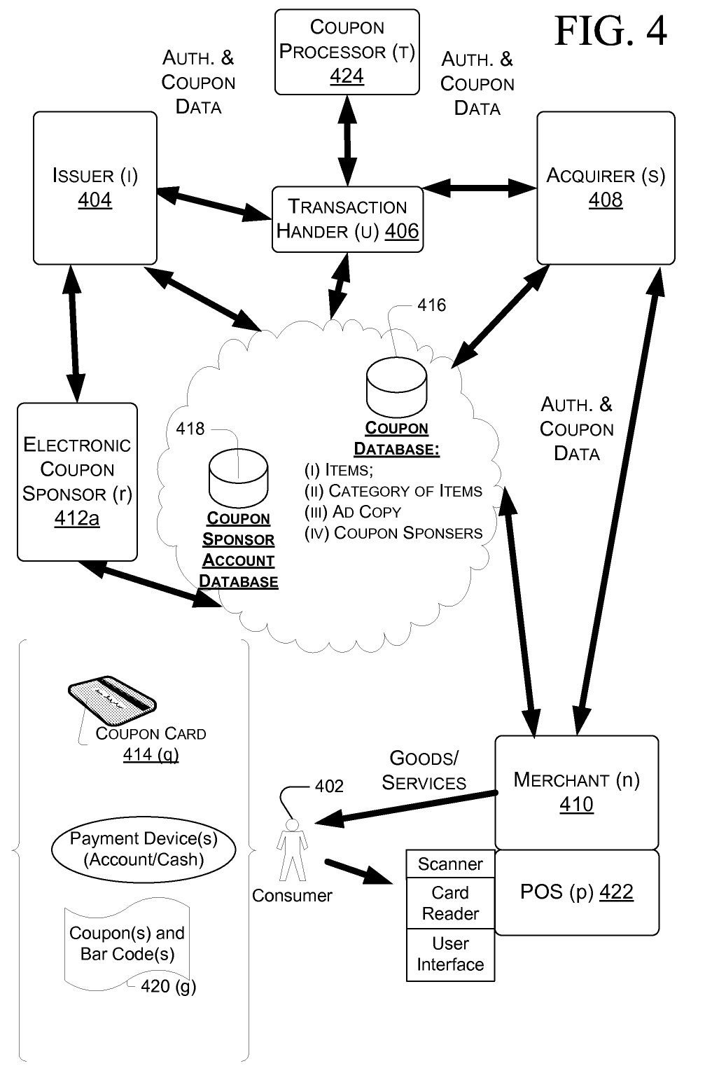

Within the exemplary payment processing system depicted in FIG. 1, discussed below, FIG. 4 illustrates the general environment wherein a coupon card, such as coupon card 302 (FIG. 3) obtained by the process described in connection with FIG. 2, is used by a consumer to receive a discount on the purchase of goods and services. To start, at POS terminal 422, consumer 402 presents to merchant 410 coupon card 414 along with the item(s) consumer 402 wishes to purchase. Merchant 410 uses a card reader associated with POS terminal 422 to read the information stored on coupon card 414, including the account identifier associated with electronic coupon sponsor 412. In certain implementations, coupon card 414 is read by swiping coupon card 414 through POS terminal 422 to read data magnetically encoded in its magstripe. In other implementations, POS terminal 422 reads coupon card 414 using a contactless technology, such as RFID, when consumer 402 is near POS terminal 422. In yet other implementations, to be read, coupon card 414 is inserted into POS terminal 422 such that external contacts on coupon card 414 establish connectivity with POS terminal 422.

In certain implementations, other information is also read from coupon card 414, such as, by way of example and not limitation, an expiration date, an item type, or an item quantity. In such implementations, POS terminal 422 may determine whether the electronic coupon is valid for the item being purchased. This may occur, by way of example and not limitation, by comparing the current date with the expiration data of the electronic coupon. Alternatively, POS terminal 422 may determine whether consumer 402 has purchased the quantity of the discounted item specified. POS terminal 422 may also verify whether consumer 402 has actually purchased the item or item type for which the electronic coupon is applicable.

In one implementation, consumer 402 additionally provides print out 420 to merchant 410. Print out 420 has a bar code printed thereon that identifies the item eligible for a discount using the electronic coupon stored on coupon card 414. In such an implementation, the bar code is scanned with a scanner associated with POS terminal 422 to identify the item that is eligible for the discount.

In certain implementations, merchant 410 may additionally enter the amount of the discount into POS terminal 422. In such implementations, the discount amount may be printed on print out 420. In other implementations, the discount amount is read by POS terminal 422 from coupon card 414. In certain implementations, POS terminal 422 calculates the discount amount. This may occur, by way of example and not limitation, where the discount is valid for the purchase of multiple items. In such an implementation, POS terminal 422 may calculate the discount amount by multiplying the discount per item by the number of items purchased.

Upon receipt of coupon card 414, the transaction is processed similarly to a method described below in connection with FIG. 1. Merchant 410 submits an authorization request to acquirer 408 via POS terminal 422, which includes the account identifier read from coupon card 414.

In certain implementations, the authorization request may additionally include an account identifier associated with consumer 402 where consumer 402 has paid for the purchase using a credit card, debit card, or other portable consumer device.

Where acquirer 408 is not the same entity as issuer 404, acquirer 408 forwards the transaction information to a transaction handler 406, who in turn forwards it to issuer 404 to verify that the account associated with electronic coupon sponsor 412 contains sufficient funds to reimburse merchant 410 for the discount.

Upon receipt of a reply from issuer 404, transaction handler 406 forwards an authorization response to acquirer 408, who forwards it to POS terminal 422 of merchant 410. Where the authorization response contains an approval of the use of the electronic coupon, consumer 402 is given a discount on the retail purchase price of the item.

In certain implementations, merchant 410 invalidates or deletes the electronic coupon(s) stored on coupon card 414 using POS terminal 422 once the discount has been applied. In certain implementations, coupon card 414 may be a one-time use card. In such an implementation, merchant 410 may forgo returning coupon card 414 to consumer 402. In other implementations, coupon card 414 may be used to store subsequent electronic coupons and therefore is returned to consumer 402.

In certain implementations, approval of the transaction may be more involved. In such implementations, the authorization request includes additional information, by way of example and not limitation, the item, the item type, and/or the sponsor of the electronic coupon. In certain implementations this information is forwarded by transaction handler 406 to coupon processor 424 for processing. In one implementation, database 416 may be used to, by way of example and not limitation, verify that electronic coupon sponsor 412 has issued the electronic coupon consumer 402 is attempting to use. In such an implementation, the authorization process may include a comparison, performed by coupon processor 424, of the additional information provided against information stored in database 416. In yet other implementations, coupon processor 424 adds a notation to a coupon stored in database 416 once it has been used by a consumer, thereby preventing the coupon from being used more than once. Coupon processor 424 may have direct access to database 416 or may access database 416 via transaction handler 406.

In other implementations, coupon processor 424 uses database 416 to keep a tally of the electronic coupons used by consumers. In such an implementation, this information is used by electronic coupon sponsor 412 in deciding future electronic coupons to issue or for identifying specific consumers for targeted advertising. In still other implementations, the additional information includes an identifier for the advertisement that was presented to consumer 402 with the electronic coupon being used. In such an implementation, after the information is stored in database 416 by coupon processor 424, electronic coupon sponsor 412 may charge another entity a fee for each time the advertisement is shown to consumers. Alternatively, electronic coupon sponsor 412 may change the advertisement associated with an electronic coupon after the advertisement has been presented with the electronic coupon a given number of times.

In other implementations, database 418 is used. As with database 416, coupon processor 424 may access database 418 directly or via transaction handler 406. Database 418 may contain information regarding the account issued to each coupon sponsor 412(r), where electronic coupon sponsor 412(r) is one of (R) coupon sponsors. In such implementations, coupon processor 424 uses database 418 to verify that the account identifier read from coupon card 414 is associated with one of the (R) electronic coupon sponsors. Database 418 may additionally be used to verify that the associated account contains funds sufficient to reimburse merchant 410 for the discount applied.

In certain implementations, coupon processor 424 is the same entity as transaction handler 406. In other implementations, coupon processor 424 is a separate entity from transaction handler 406.

When merchant 410 submits the transaction to payment processing system 400 via POS terminal 422 for clearing and settlement, the account of electronic coupon sponsor 412 is debited for the cost of the discount. Specifically, merchant 410 submits a request for payment to acquirer 408. Where acquirer 408 is not the same entity as issuer 404, acquirer 408 forwards the request to transaction handler 406. Transaction handler 406 in turn requests payment for the discount from issuer 404, where issuer 404 is the issuer of the account associated with electronic coupon sponsor 412. Issuer 404 debits the account and forward the payment to transaction handler 406 who forwards the payment to acquirer 408. Finally, acquirer 408 credits the account of merchant 410 with the amount of the discount.

In certain implementations, the clearing and settlement process may involve coupon processor 424. In such an implementation, coupon processor 424 may, by way of example and not limitation, record each electronic coupon that has been cleared and settled. This record may be kept in database 416 or in another separate database. Alternatively or in addition to, coupon processor may verify that the electronic coupon was used in the transaction being cleared and settled. In yet other implementations, coupon processor 424 may determine the account associated with coupon sponsor 412 in order that transaction handler 406 may request issuer 404 debit that account. In such implementations, coupon processor 424 may access database 418.

As will be understood by a person of ordinary skill in the art, the process described in connection with FIG. 4 is equally applicable to the situation where a consumer uses a coupon card having multiple electronic coupons stored thereon to receive a discount on several items. In such a situation, the electronic coupons may be provided by different electronic coupon sponsors having accounts issued by different issuers. Further, it will be clear to a person of ordinary skill in the art that a coupon card may have multiple electronic coupons stored thereon that are valid at different merchants, each having a different acquirer.

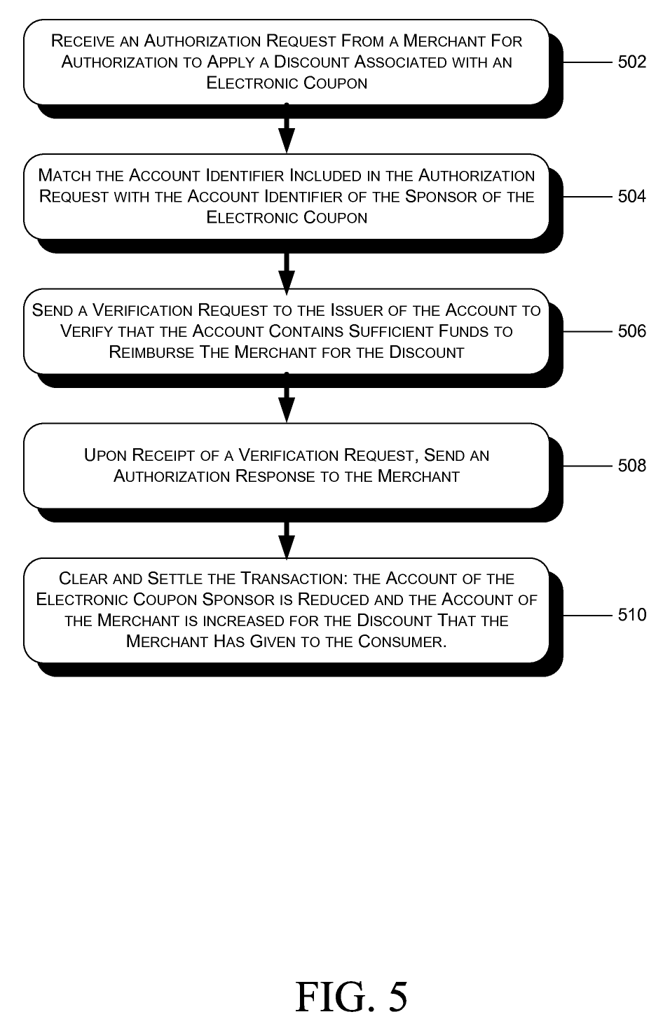

Turning now to FIG. 5, a flow chart of an exemplary method used by a transaction handler to process an electronic coupon stored on a coupon card is presented. As indicated by block 502, the transaction handler receives an authorization request from a merchant, requesting authorization to apply a discount associated with an electronic coupon to a transaction. Upon receipt of the request, the transaction handler matches the account identifier included in the request with the account identifier associated with the electronic coupon sponsor, as indicated by block 504. In certain implementations, the matching is performed by a coupon processor. In such implementations the coupon processor may be a separate entity from the transaction handler. In certain implementations, if the account identifier included in the request does not match the account identifier associated with the electronic coupon sponsor, the transaction handler sends an authorization response to the merchant containing a denial of the coupon. In such an implementation, the process may end.

In the illustrated implementation of FIG. 5, the transaction handler next sends a request to the issuer of the account associated with the electronic coupon sponsor requesting verification that the account contains sufficient funds to reimburse the merchant for the discount, as indicated by block 506. As indicated by block 508, upon receipt of a response from the issuer, the transaction handler sends a response to the merchant. Where the issuer confirms that the account contains sufficient funds, the authorization request may contain an approval. Finally, as indicated by block 510, the transaction handler clears and settles the transaction by requesting that the issuer debit the account of the electronic coupon sponsor and an acquirer for the merchant credit the merchant's account for the discount applied.

In certain implementations, individual blocks described above may be combined, eliminated, or reordered.

In certain implementations, instructions are encoded in computer readable medium wherein those instructions are executed by a processor to perform one or more of the blocks 502, 504, 506, 508, and 510 recited in FIG. 5.

In yet other implementations, instructions reside in any other computer program product, where those instructions are executed by a computer external to, or internal to, a computing system to perform one or more of the blocks 502, 504, 506, 508, and 510 recited in FIG. 5. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

As an example of how the described coupon card may used, a consumer may take a coupon card with them to the grocery store, where the coupon card has at least one coupon stored thereon. At the check-out counter, the consumer provides the coupon card and a print out of bar codes to the cashier. The cashier swipes the magnetic strip of the coupon card through the POS terminal and scans the bar codes on the print out. The cashier then scans the SKU/UPCs for each item the consumer is purchasing. The POS terminal determines if the electronic coupons apply to any of the items by comparing the bar codes with the scanned SKU/UPCs. For example, the coupon card may contain multiple electronic coupons, one of which is for a discount on bread and is provided by the manufacturer of the bread. Another electronic coupon, provided by the grocery store, may be for a discount on pet food. When the POS terminal receives the SKU/UPCs for a loaf of bread and a bag of pet food, the POS terminal requests authorization to apply a discount to the items. The authorization request is, for example, received by the grocery store's acquirer.

As the acquirer is the issuer of the account associated with the grocery store, the acquirer verifies if the account has been credited with sufficient funds to pay for the discount on the pet food and sends an authorization response to the POS terminal. The request for authorization to apply a discount to the bread is forwarded by the acquirer to a transaction handler for processing. The transaction handler in turn may forward a request to the issuer of the manufacturer's account for verification that the account contains sufficient funds. Upon receiving a response, the transaction handler may send an authorization response authorizing the application of the discount to the bread.

Once the POS terminal receives the authorization responses for both coupons, the discounts are applied. The consumer may then use the coupon card to pay for the items, where the coupon card is associated with an account of the consumer's, or the consumer may use an alternative payment method.

### An Exemplary Transaction Processing System

Referring to FIG. 1, a transaction processing system 100 is seen. The general environment of FIG. 1 include that of a merchant (m) 110, such as the merchant, who can conduct a transaction for goods and/or services with an account user (au) (e.g., consumer) on an account issued to an account holder (a) 108 by an issuer (i) 104, where the processes of paying and being paid for the transaction are coordinated by at least one transaction handler (th) 102 (e.g., the transaction handler) (collectively “users”). The transaction includes participation from different entities that are each a component of the transaction processing system 100.

The transaction processing system 100 may have at least one of a plurality of transaction handlers (th) 102 that includes transaction handler (1) 102 through transaction handler (TH) 102, where TH can be up to and greater than an eight digit integer.

The transaction processing system 100 has a plurality of merchants (m) 110 that includes merchant (1) 110 through merchant (M) 110, where M can be up to and greater than an eight digit integer. Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant (m) 110 making a purchase from another merchant (m) 110.

Transaction processing system 100 includes account user (1) 108 through account user (AU) 108, where AU can be as large as a ten digit integer or larger. Each account user (au) conducts a transaction with merchant (m) 110 for goods and/or services using the account that has been issued by an issuer (i) 104 to a corresponding account holder (a) 108. Data from the transaction on the account is collected by the merchant (m) 110 and forwarded to a corresponding acquirer (a) 106. Acquirer (a) 106 forwards the data to transaction handler (th) 102 who facilitates payment for the transaction from the account issued by the issuer (i) 104 to account holder (a) 108.

Transaction processing system 100 has a plurality of acquirers (q) 106. Each acquirer (q) 106 may be assisted in processing one or more transactions by a corresponding agent acquirer (aq) 106, where ‘q’ can be an integer from 1 to Q, where aq can be an integer from 1 to AQ, and where Q and AQ can be as large as a eight digit integer or larger. Each acquirer (q) 106 may be assisted in processing one or more transactions by a corresponding agent acquirer (aq) 106, where ‘q’ can be an integer from 1 to Q, where aq can be an integer from 1 to AQ, and where Q and AQ can be as large as a eight digit integer or larger.

The transaction handler (th) 102 may process a plurality of transactions within the transaction processing system 100. The transaction handler (th) 102 can include one or a plurality or networks and switches (ns) 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (e.g., private communication network(s)) facilitate communication between the transaction handler (th) 102 and each issuer (i) 104 and each acquirer (a) 106. A Network 112, via e-mail, the World Wide Web, cellular telephony, and/or other optionally public and private communications systems, can facilitate communications 122a-622e among and between each issuer (i) 104, each acquirer (a) 106, each merchant (m) 110, each account holder (a) 108, and the transaction handler (th) 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively.

The Network 112 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 112 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 112 may utilize any of a variety of communication protocols, such as Transmission Control Protocol/Internet Protocol (TCP/IP), for example. There may be multiple nodes within the network 112, each of which may conduct some level of processing on the data transmitted within the transaction processing system 100.

Users of the transaction processing system 100 may interact with one another or receive data about one another within the transaction processing system 100 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 100 by the account holder (a) 108 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 108's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 110 may utilize at least one POI terminal (e.g., Point of Service or browser enabled consumer cellular telephone); that can communicate with the account user (au) 108, the acquirer (a) 106, the transaction handler (th) 102, or the issuer (i) 104. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 110 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 100.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 110. These data can include an account identifier of a healthcare account. In another example, the POI may be the PCD of the consumer, such as the cellular telephone of the consumer, where the merchant (m) 110, or an agent thereof, receives the account identifier of the consumer via a webpage of an interactive website rendered by a browser executing on a World Wide Web (Web) enabled PCD.

Typically, a transaction begins with account user (au) 108 presenting the portable consumer device to the merchant (m) 110 to initiate an exchange for resources (e.g., a good or service). The portable consumer device may be associated with an account (e.g., a credit account) of account holder (a) 108 that was issued to the account holder (a) 108 by issuer (i) 104.

Merchant (m) 110 may use the POI terminal to obtain account information, such as a number of the account of the account holder (a) 108, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 104 of the account associated with the PCD. Alternatively, or in combination, the PCD may communicate with issuer (i) 104, transaction handler (th) 102, or acquirer (a) 106.

Issuer (i) 104 may authorize the transaction and forward same to the transaction handler (th) 102. Transaction handler (th) 102 may also clear the transaction. Authorization includes issuer (i) 104, or transaction handler (th) 102 on behalf of issuer (i) 104, authorizing the transaction in connection with issuer (i) 104's instructions such as through the use of business rules. The business rules could include instructions or guidelines from the transaction handler (th) 102, the account holder (a) 108, the merchant (m) 110, the acquirer (a) 106, the issuer (i) 104, a related financial institution, or combinations thereof. The transaction handler (th) 102 may, but need not, maintain a log or history of authorized transactions. Once approved, the merchant (m) 110 may record the authorization, allowing the account user (au) 108 to receive the good or service from merchant (m) or an agent thereof.

The merchant (m) 110 may, at discrete periods, such as the end of the day, submit a list of authorized transactions to the acquirer (a) 106 or other transaction related data for processing through the transaction processing system 100. The transaction handler (th) 102 may optionally compare the submitted authorized transaction list with its own log of authorized transactions. The transaction handler (th) 102 may route authorization transaction amount requests from the corresponding the acquirer (a) 106 to the corresponding issuer (i) 104 involved in each transaction. Once the acquirer (a) 106 receives the payment of the authorized transaction from the issuer (i) 104, the acquirer (a) 106 can forward the payment to the merchant (m) 110 less any transaction costs, such as fees for the processing of the transaction. If the transaction involves a debit or pre-paid card, the acquirer (a) 106 may choose not to wait for the issuer (i) 104 to forward the payment prior to paying merchant (m) 110.

There may be intermittent steps in the foregoing process, some of which may occur simultaneously. For example, the acquirer (a) 106 can initiate the clearing and settling process, which can result in payment to the acquirer (a) 106 for the amount of the transaction. The acquirer (a) 106 may request from the transaction handler (th) 102 that the transaction be cleared and settled. Clearing includes the exchange of financial information between the issuer (i) 104 and the acquirer (a) 106 and settlement includes the exchange of funds. The transaction handler (th) 102 can provide services in connection with settlement of the transaction. The settlement of a transaction includes depositing an amount of the transaction settlement from a settlement house, such as a settlement bank, which transaction handler (th) 102 typically chooses, into a clearinghouse bank, such as a clearing bank, that acquirer (a) 106 typically chooses. The issuer (i) 104 deposits the same from a clearinghouse bank, such as a clearing bank, which the issuer (i) 104 typically chooses, into the settlement house. Thus, a typical transaction involves various entities to request, authorize, and fulfill processing the transaction.

The transaction processing system 100 will preferably have network components suitable for scaling the number and data payload size of transactions that can be authorized, cleared and settled in both real time and batch processing. These include hardware, software, data elements, and storage network devices for the same. Examples of transaction processing system 100 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 104 (or agent issuer (ai) 104 thereof) and each acquirer (a) 106 (or agent acquirer (aq) 106 thereof) can use or more router/switch (e.g., Cisco™ routers/switches) to communicate with each network/switch (ns) 102 via dedicated communication systems.

Transaction handler (th) 102 can store information about transactions processed through transaction processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 100 over paying and being paid by cash, or other traditional payment mechanisms.

The VisaNet® system is an example component of the transaction handler (th) 102 in the transaction processing system 100. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 110. In 2007, around 81 billion transactions for about 4 trillion U.S. dollars were cleared and settled through the VisaNet® system, some of which involved a communication length of around 24,000 miles in around two (2) seconds and during which a plurality of stops are made for processing data in the transaction.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable coupon payment device comprising:
a substrate having surface with an image rendering thereon that corresponds to a free sample;
and
memory, in contact with the substrate, having data encoded therein including:
an identifier for the free sample; and
a quantity for the free sample;
a sponsor company account for a selling merchant to charge the cost of the free sample for payment to a selling merchant account to reimburse the selling merchant for the free sample;
an image corresponding to the free sample; and
an identifier for a coupon provider donating the free sample to a consumer.

2. The portable coupon payment device as defined in claim 1, wherein:
the sponsor company account is a type of consumer account issued by an issuer to a sponsor company;
the portable coupon payment device is a type of a portable coupon payment device that is associated with a consumer account for a consumer to engage in a plurality of transactions on the consumer account with a plurality of merchants in a payment processing network;
the payment processing network includes a plurality of merchants and consumers engaging in a plurality of transactions on a plurality of respective consumer accounts that respective issuers issue to the consumers; and
each said transaction involves the merchant submitting the transaction to an acquirer for processing by a transaction handler who requests the issuer to obtain payment for the transaction from the consumer account, and wherein the issuer forwards the payment to the transaction handler who forwards the payment to the acquirer to reimburse the merchant for the transaction.

3. The portable coupon payment device as defined in claim 1, wherein the data encoded in the memory further includes an image of a donation for the consumer from the coupon provider.

4. The portable coupon payment device as defined in claim 3, wherein the image of the donation comprises respective images corresponding to:
the identifier for the consumer;
the identifier for the coupon provider of the free sample;
the identifier for the free sample; and
the quantity of the free sample.

5. The portable coupon payment device as defined in claim 1, wherein the image corresponding to the free sample includes a code identifying the free sample and configured for being scanned by a scanner at a Point of Service terminal.

6. The portable coupon payment device as defined in claim 1, wherein the image corresponding to the free sample includes an advertisement selected from the group consisting of:
an advertisement for the free sample;
an advertisement not for the free sample;
an advertisement for the selling merchant;
an advertisement for a different product other than the free sample that is also provided by the selling merchant; and
a combination of the foregoing.

7. The portable coupon payment device as defined in claim 1, wherein the image corresponding to the free sample includes an advertisement selected from the group consisting of:
an advertisement for a merchant geographically proximal to the coupon provider;
an advertisement for a merchant geographically proximal to the selling merchant; and
a combination of the foregoing.

8. The portable coupon payment device as defined in claim 1, wherein the memory of the portable coupon payment device is selected from the group consisting of:
a non-volatile memory of a semiconductor device;
a magnetic encoded data region of a magnetic stripe; and
a combination of the foregoing.

9. The portable coupon payment device as defined in claim 1, wherein the substrate is a portion of a consumer transaction payment card selected from the group consisting of:
a smart card having a Radio Frequency Identification (RFID) tag, a transponder device and a microchip; and
a magstripe card; and
a combination of the foregoing.

10. The portable coupon payment device as defined in claim 1, further comprising means for the memory to receive the information by a communication selected from the group consisting of a wireless communication, a hardwired communication, and a magnetic encoded communication for track data received by modifying the magnetism of magnetic particles on a band of magnetic material on the portable coupon payment device.

11. The portable coupon payment device as defined in claim 1, wherein data in the memory of the portable coupon payment device further comprises an identifier, a quantity, and a quantity of an item, other than the free sample, being donated by the coupon provider to the consumer.

12. The portable coupon payment device as defined in claim 11, wherein the identifier for the free sample and the identifier for the item, other than the free sample, are both selected from the group consisting of:
a Stock Keeping Unit (SKU);
a Universal Product Code (UPC);
a trademark;
a commodity type and a trade name of a provider of the commodity type;
an ingredient of the commodity type and the trade name of the provider of the commodity type; and
a combination of the foregoing.

13. A portable coupon transaction payment device comprising:
memory, embedded in a substrate, having stored therein:
an identifier and a quantity for each of a plurality of:
a free sample donated by a coupon provider to a consumer; and
a non-sample item each being offered by a corresponding said coupon provider to the consumer;
for each said free sample, a sponsor company account for a selling merchant to charge the cost of the free sample for payment to a selling merchant account to reimburse the selling merchant for the free sample;
an identifier for the consumer;
an identifier for each said coupon provider;
an identifier for a consumer account issued by an issuer to the consumer; and
an identifier to correlate which said donation for the consumer was donated by which said coupon provider, wherein:
the sponsor company account and the consumer account are each an account in a payment processing network by which a consumer can engage in a plurality of transactions on the account with a plurality of merchants in the payment processing network;
the payment processing network includes a plurality of said merchants and said consumers engaging in the plurality of said transactions on a plurality of respective said accounts that respective said issuers issue to the consumers; and
each said transaction involves the merchant submitting the transaction to an acquirer for processing by a transaction handler who requests the issuer to obtain payment for the transaction from the account, wherein the issuer forwards the payment to the transaction handler who forwards the payment to the acquirer to reimburse the merchant for the transaction;
and
means for providing access to the information in the memory.

14. The portable coupon transaction payment device as defined in claim 13, wherein the consumer account issued by the issuer to the consumer is a type selected from the group consisting of a debit account, a credit account, a prepaid account, and a gift card account.

15. The portable coupon transaction payment device as defined in claim 13, wherein the substrate has an image in a surface that the includes representing at least a portion of the information in the memory for being read by the image being scanned by a scanner at a Point of Service terminal.

16. The portable coupon transaction payment device as defined in claim 13, wherein the memory is selected from the group consisting of:
a non-volatile memory of a semiconductor device;
a magnetic encoded data region of a magnetic stripe; and
a combination of the foregoing.

17. The portable coupon transaction payment device as defined in claim 13, wherein the substrate is a portion of a consumer transaction payment card selected from the group consisting of:
a smart card having a Radio Frequency Identification (RFID) tag, a transponder device and a microchip; and
a magstripe card; and
a combination of the foregoing.

18. The portable coupon transaction payment device as defined in claim 13, wherein the information in the memory further includes an image of each said free sample for the consumer that was donated by the corresponding said coupon provider.

19. The portable coupon transaction payment device as defined in claim 18, wherein, for each said image of each said free sample, the free sample in the image is hand written by the coupon provider.

20. The portable coupon transaction payment device as defined in claim 18, further comprising means for the memory to receive the information by a communication selected from the group consisting of a wireless communication, a hardwired communication, and a magnetic encoded communication for track data received by modifying the magnetism of magnetic particles on a band of magnetic material on the portable coupon payment device.

21. The portable coupon transaction payment device as defined in claim 20, wherein, for each said image of each said free sample, the identifier for the coupon provider comprises a handwritten signature of the coupon provider.

22. The portable coupon transaction payment device as defined in claim 18, wherein each said image of each said free sample comprises respective images corresponding to:
the identifier for the consumer;
the identifier for the coupon provider; and
the identifier and the quantity for the free sample; and
the identifier, quantity, and dosage identifier for the non-sample item.

23. A portable coupon transaction payment device comprising:
memory, embedded in a substrate, having information stored therein, wherein:
the substrate has an image on a surface thereof that includes a representation of at least a portion of the information in the memory for being read by the image being scanned by a scanner at a Point of Service terminal:
the information includes:
an identifier and a quantity for each of a plurality of:
a free sample donated by a coupon provider to a consumer; and
a non-sample item offered by a corresponding said coupon provider to the consumer;
an image, having multiple portion, of each said donation for the consumer that was donated by the corresponding said coupon provider, wherein the portions of the image correspond to:
the identifier for the consumer;
the identifier for the coupon provider; and
the identifier and the quantity for the free sample; and
the identifier and the quantity for the non-sample item;
for each said free sample, a sponsor company account for a selling merchant to charge the cost of the free sample for payment to a selling merchant account to reimburse the selling merchant for the free sample; and
an identifier to correlate which said donation for the consumer was donated by which said coupon provider, wherein:
the sponsor company account and the consumer account are each an account in a payment processing network by which a consumer can engage in a plurality of transactions on the account with a plurality of merchants in the payment processing network;
the payment processing network includes a plurality of said merchants and said consumers engaging in the plurality of said transactions on a plurality of respective said accounts that respective said issuers issue to the consumers; and
each said transaction involves the merchant submitting the transaction to an acquirer for processing by a transaction handler who requests the issuer to obtain payment for the transaction from the account, wherein the issuer forwards the payment to the transaction handler who forwards the payment to the acquirer to reimburse the merchant for the transaction;
and
means for providing access to the information in the memory.

24. The portable coupon transaction payment device as defined in claim 23, wherein the memory is selected from the group consisting of:
a non-volatile memory of a semiconductor device;
a magnetic encoded data region of a magnetic stripe; and
a combination of the foregoing.

25. The portable coupon transaction payment device as defined in claim 23, wherein the substrate is a portion of a consumer transaction payment card selected from the group consisting of:
a smart card having a Radio Frequency Identification (RFID) tag, a transponder device and a microchip; and
a magstripe card; and
a combination of the foregoing.

26. The portable coupon transaction payment device as defined in claim 23, further comprising means for the memory to receive the information by a communication selected from the group consisting of a wireless communication, a hardwired communication, and a magnetic encoded communication for track data received by modifying the magnetism of magnetic particles on a band of magnetic material on the portable coupon payment device.

27. The portable coupon transaction payment device as defined in claim 23, wherein, for each said image of each said donation, the identifier for the coupon provider comprises a handwritten signature of the coupon provider.

28. The portable coupon transaction payment device as defined in claim 23, wherein, for each said image of each said free sample, the free sample in the image is hand written by the coupon provider.
